(19) United States
(12) Patent Application Publication
(10) Pub. No.: US 2018/0165117 A1
(43) Pub. Date: Jun. 14, 2018

(54) Software Switch Hypervisor for Isolation of Cross-Port Network Traffic

(71) Applicant: John Reumann, (US)

(72) Inventors: John Reumann, Croton on Hudson, NY (US); Lazaros Koromilas, Cambridge (GB); Zhang Xu, Croton on Hudson, NY (US)

(73) Assignee: NoFutzNetworks Inc., Croton on Hudson, NY (US)

(21) Appl. No.: 15/373,013

(22) Filed: Dec. 8, 2016

(51) Int. Cl. G06F 9/48; G06F 9/455; G06F 13/40; G06F 9/50; G06F 11/30

(52) U.S. Cl. CPC G06F 9/48; G06F 9/45558; G06F 13/4022; G06F 9/5055; G06F 11/3485; G06F 11/3024; G06F 11/3051; G06F 2009/45587; G06F 11/301

(57) ABSTRACT

This invention provides a new mechanism to provide performance isolation between the different port-and-direction pairs of a software switch. This is accomplished by mapping each port-pair and direction to its own Operating System process. This improves performance, fault, and rule-space isolation between the ports of a software-based network switch on general purpose CPUs. This invention makes it possible to use standard OS mechanisms and commands to control the per-port isolation of network packet forwarding on a software switch.

### TECHNICAL FIELD

Network Routing and network data processing on general purpose central processing units (CPUs) specifically as it relates to centrally controlled networks

### BACKGROUND OF THE INVENTION

This present invention considers the technical problem of receiving data on one port and passing the network data through to another port in a Software Switch (SWS). Port in this context is a pair of one receive (RX) and one transmit (TX) queue. A port is either physical or virtual. A physical port is backed by memory queues on a network interface card a device, while a virtual port is entirely in a host computer's memory.

The passing operation is implemented bi-directionally at full network speed. The function that passes the network data between the two interfaces, henceforth Network Program (NP), may count, filter, or alter the data prior to (or in parallel to) passing the data the other physical port. An NP may include several functions, e.g., one to count, and another to alter the inflight data.

Scaling NP processing in an SWS across many CPUs, is difficult because it's a highly application-dependent problem. A specific application family of concern to the Inventors is the so called “bump-in-the-wire” applications, that interpose NPs on the forwarding path while maintaining full-duplex connectivity between a set of bridged ports. SWSes are typically optimized for many-port, switch emulation applications, with great emphasis on features and average throughput and less on performance isolation. In a standard SWS, an overload due to excessive traffic on one interface (e.g., caused by a denial of service attack on said interface) can negatively impact traffic in another, unrelated network interface.

System and network operators require switch performance to remain predictable and limit the damage done by traffic overload or a potential denial of service (DoS) flood by isolating its effect in one port or a small set of ports.

SWSes run on standard operating system servers which are best administered through standard command line interfaces. Therefore, it is of substantial utility that the control mechanisms for network traffic regarding the SWS herein map to standard abstractions for workload isolation on a CPU, i.e., processes. This is different from the controls available on the SWS itself which are orthogonal to those of the Operating System.

While the problem of isolation applies to the forwarding between any two ports of an SWS, the discussion of this invention shall be limited (without loss of generality) to describing a method that isolates the two directions in a single port pair: inbound and outbound, a two-port bump-in-the wire. The 1-to-1 case needs to support the same isolation features as the n-to-m forwarding case: forwarding rules per port, monitoring, accounting, access controls, and performance (overload in one port-direction should not affect any other).

Unlike a hardware switch which can only support few traffic rules (limited by the size of TCAM memory), an SWS could theoretically support millions of traffic rules, because it is not constrained by TCAM memory. However, a single software switch typically only maintains a single connection to a controller from which it loads its rules. Therefore, an SWS that accommodates many ports will not be able to download and apply a large enough number of rules per port per second. Today's SWS implementations artificially constrain per port rule update rates by relying on a single control connection.

Furthermore, an SWS implementation is backed by a single database. This database creates artificial update ordering and shared update per second constraints between switch ports. In many use cases in which different ports do not need to be atomically updated relative to other ports, the shared per SWS database introduces an artificial constraint between ports, and thereby limiting update rates and the benefits of an SWS relative to hardware.

This invention substantially improves linkage between two ports that are forwarding to each each other while also executing packet processing on an SWS as packets transit between the ports.

### PRIOR ART

The following paragraphs describe related inventions and published works of prior art that are applicable to the same or variants of this problem, solutions that seem to relate to this invention but for subtle reasons fail to address the problems described above, and other inventions upon which this invention builds. A list of detailed document references is provided following the discussion of Prior Art.

This invention executes NPs, and specifically through SWS instances, inside application containers. Containers have been used in networking applications for evaluating topologies and testing purposes in U.S. Pat. No. 7,733,795B2. This case is different from this invention in that an SWS is used to connect virtual networks that correspond to sets of containers, for the purpose of testing various topologies. The containers are meant to represent virtual hosts. This invention runs many SWS instances inside of containers for isolation.

This invention's SWHYPE unit, when configured with an NP that just forwards packets, appears as a two-port network switch U.S. Pat. No. 9,426,095B2. But that's just a special case of the possible functional NPs. OVS is the SWS implementation used in this invention.

OVS has been used in mSwitch [MSWITCH] in conjunction with a netmap-based [NETMAP] kernel-bypass userspace network datapath [VALE]. VALE adds virtual ports functionality to netmap, accessible through the netmap API by applications. So in the case of mSwitch, it is used in a similar way DPDK is used in this invention. This invention, however, adopts a very specific model to configure the OVS switch, with a single port per instance, and two instances per pair of physical ports, so that both traffic directions between two physical ports are accounted for. Furthermore, VALE has been used as a networking backend for containers in VALELXC. The elements running behind VALEXC, however, are applications, not components of a dis-aggregated virtual switch.

SWHYPE utilizes NIC multi-queue and/or NIC virtualization features for sharing NIC port queues. These are considered widely supported technologies [U.S. Pat. No. 8,014,413B2] [IOVIRT]. The reason for sharing an I/O device is for partitioning the bandwidth space it offers and distribute it into more than one SWHYPEs. There are more combinations of port-pair directions than the number of ports, in a system with more than two physical ports.

Patent U.S. Pat. No. 8,340,090B1 describes a forwarding plane and switching mechanism that optimizes operations for devices that house many forwarding contexts (logically, routers and their tables) in a single physical device. Specifically it introduces the concept of a U-turn port that combines information from many contexts and passes through packets that would otherwise need to reach an external router and come back. This is similar to this invention's pre-filtering style checking, for example when known types of packets are handled early at the hypervisor level, before doing any further processing by the SWS. This invention, however, provides transparent full-packet data-plane processing (e.g., no TTL decrements or other modifications required). Also packet processing (or forwarding if that's how it's configured by the controller) is performed at an SWS between two physical ports, separately for each traffic direction. A key distinction is that this invention creates a single forwarding plane out of a set of disaggregated port-direction connection pairs, while the cited patent U.S. Pat. No. 8,340,090B1 is primarily concerned about the case in which a single switch is application is shared among multiple forwarding applications in a complex manner.

Obtaining unique physical port identifiers, from which virtual port names and datapath identifiers are derived, is not part of this invention. A static configuration is assumed, but the system described in this invention can benefit from dynamic provisioning and topology configuration solutions like the ones described in U.S. Pat. No. 9,032,054B2, U.S. Pat. No. 9,229,749B2, U.S. Pat. No. 8,830,823B2 or US20160057006A1.

Patent U.S. Pat. No. 8,959,215B2 aims to improve the art in managing the network as a virtualized resource, for use in data-center settings and multi-tenant setups while providing centralized logical control. This is achieved by decoupling the forwarding plane from the control path and implementing a network hypervisor layer above the OS. This invention, also uses a hypervisor but the role of this hypervisor is distinct from the role of a hypervisor in this cited patent U.S. Pat. No. 8,959,215B2. The hypervisor of the cited patent virtualizes the concept of a network switch by exposing a unified and separate control plane that virtualizes all controls and maps those to a potentially distributed data plane. The patent does not describe how isolation is to be achieved on a multi-core CPU implementation of the dataplane.The dataplane hypervisor of U.S. Pat. No. 8,959,215B2 is called a Software Switch in this present invention.

### LIST OF DOCUMENTS REFERENCES AS PRIOR ART

### U.S. Patents and Patent Applications

Pat. No. 8,340,090B1
Title: “Interconnecting forwarding contexts using u-turn ports”
Inventors: John H. W. Bettink, David Delano, Ward Pawan and Uberoy
Assignee: Cisco Technology Inc.
Priority date: Mar. 8, 2007
Filing date: Mar. 8, 2007
Publication date: Dec. 25, 2012
Grant date: Dec. 25, 2012
Pat. No. 9,426,095B2
Title: “Apparatus and method of switching packets between virtual ports”
Inventors: Vijoy Pandey, Rakesh Saha
Assignee: International Business Machines Corp.
Priority date: Aug. 28, 2008
Filing date: Aug. 28, 2009
Publication date: Aug. 23, 2016
Grant date: Aug. 23, 2016
Pat. No. 8,014,413B2
Title: “Shared input-output device”
Inventors: Gregory D. Cummings, Luke Chang
Assignee: Intel Corp.
Priority date: Aug. 28, 2006
Filing date: Aug. 28, 2006
Publication date: Sep. 6, 2011
Grant date: Sep. 6, 2011
Pat. No. 7,733,795B2
Title: “Virtual network testing and deployment using network stack instances and containers”
Inventor: Darrin P. Johnson, Erik Nordmark, Kais Belgaied
Assignee: Oracle America Inc.
Priority date: Nov. 28, 2006
Filing date: Nov. 28, 2006
Publication date: Jun. 8, 2010
Grant date: Jun. 8, 2010
Pat. No. 9,032,054B2
Title: “Method and apparatus for determining a network topology during network provisioning”
Inventors: Amit Shukla and Arthi Ayyangar
Assignee: Juniper Networks Inc.
Priority date: Dec. 30, 2008
Filing date: Aug. 24, 2012
Publication date: May 12, 2015
Grant date: May 12, 2015
Patent Application 20160057006A1
Title: “Method and system of provisioning logical networks on a host machine”
Inventors: Sachin Thakkar, ChiHsiang Su, Jia Yu, Piyush Kothari and Nilesh
Ramchandra Nipane
Assignee: VMware Inc.
Priority date: Aug. 22, 2014
Filing date: Aug. 23, 2014
Publication date: Feb. 25, 2016
Pat. No. 9,229,749B2
Title: “Compute and storage provisioning in a cloud environment”
Inventors: Varagur Chandrasekaran
Assignee: Cisco Technology Inc.
Priority date: Oct. 31, 2011
Filing date: Oct. 31, 2011
Publication date: May 1, 2016
Grant date: May 1, 2016
Pat. No. 8,830,823B2
Title: “Distributed control platform for large-scale production networks”
Inventors: Teemu Koponen, Martin Casado, Natasha Gude and Jeremy Stribling
Assignee: NICIRA Inc.
Priority date: Jul. 6, 2010
Filing date: Jul. 6, 2011
Publication date: Sep. 9, 2014
Grant date: Sep. 9, 2014
Pat. No. 8,959,215B2
Title: “Network virtualization”
Inventors: Teemu Koponen, Martin Casado, Paul S. Ingram, W. Andrew Lambeth, Peter J. Balland III, Keith E. Amidon and Daniel J. Wendlandt
Assignee: NICIRA Inc.
Priority date: Jul. 6, 2010
Filing date: Jul. 6, 2011
Publication date: Feb. 17, 2015
Grant date: Feb. 17, 2015

### Other Publications

[OVS] Ben Pfaff, Justin Pettit, Teemu Koponen, Ethan Jackson, Andy Zhou, Jarno Rajahalme, Jesse Gross, Alex Wang, Joe Stringer, Pravin Shelar, Keith Amidon and Martin Casado. “The design and implementation of open vswitch.” 12th USENIX symposium on networked systems design and implementation (NSDI 15). USENIX, 2015.
[NETMAP] Luigi Rizzo. “Netmap: a novel framework for fast packet I/O.” 21st USENIX Security Symposium (USENIX Security 12). USENIX, 2012.
[VALE] Luigi Rizzo and Giuseppe Lettieri. “Vale, a switched ethernet for virtual machines.” Proceedings of the 8th international conference on Emerging networking experiments and technologies. ACM, 2012.
[MSWITCH] Michio Honda, Felipe Huici, Giuseppe Lettieri and Luigi Rizzo. “mSwitch: a highly-scalable, modular software switch.” Proceedings of the 1st ACM SIGCOMM Symposium on SDN Research (SOSR 2015). ACM, 2015.
[VALELXC] Maurizio Casoni, Carlo Augusto Grazia and Natale Patriciello. “On the performance of Linux container with netmap/VALE for networks virtualization.” Proceedings of the 19th IEEE International Conference on Networks (ICON 2013). IEEE, 2013.
[IOVIRT] Carl Waldspurger and Mendel Rosenblum. “I/O Virtualization.” Communications of the ACM, Vol. 55 No. 1, Pages 66-73. ACM, 2012.
[DOCKER] Dirk Merkel. “Docker: lightweight linux containers for consistent development and deployment.” Linux Journal 2014, no. 239. 2014.

### SUMMARY OF THE INVENTION

It is the goal of this present invention to ensure that bridging between any two ports works as follows: packets arriving on the “outside” port are sent to the “inside” port and vice versa. The SWS may mangle, drop, or pass the packets in either direction. Two directions are identified in this setup, the inbound and the outbound direction, each direction is handled by its own operating system process.

Packets flowing in each direction are handled by a full, separate dedicated SWS instance, which is scheduled to run on its own dedicated CPU core. This is a new approach to scaling SWSes. Each combination of ports and directions is associated with its own CPU core and OS process. In contrast, a standard software switch [OVS] uses a shared set of cores for the SWS application running within a shared process, for a large number of ports, thus using any core for any port and direction of packet forwarding. This invention, however, enforces that each CPU and process only serves a single (or few) direction and port pair(s).

Furthermore, to properly isolate the SWS, it is executed inside a resource container. In this present invention the SWS process does not gain direct access to the Network Interface Card (NIC), to prevent interference among the virtual switch directions that converge on the same NIC. The SWS attaches to its dedicated virtual port. Access to the NIC is moderated by the Software Switch Hypervisor (SWHYPE).

There can be multiple SWHYPE instances in an SWHYPE-hosting node, each handling its own subset of physical ports and virtual ports. We call the memory and resources managed by an SWHYPE, an isolation domain.

Traffic reaching a physical port of an SWHYPE needs to have been routed there by other means (e.g., hardware switch rules), because the SWHYPE only implements a single forwarding plane in two directions, so it provides post-routing processing.The following statements outline the setup of the solution:

Each CPU or isolated CPU slice runs exactly one separate SWS instance.

Each SWS instance is responsible for exactly one direction between a pair of physical ports on the system.

Each SWS executes in its own resource container.

Each SWS is run behind an SWS hypervisor (SWHYPE) that protects the SWS from unwanted or malicious traffic.

Each instance of the SWS is deployed with a single virtual port that connects to the SWHYPE using shared memory.

There can be many SWHYPE-hosting nodes that collectively form a namespace. The name of a virtual port is global in that namespace and can be any unique value in that scope.

### Advantageous Effects of the Invention

Each direction of traffic can only affect a single CPU core, i.e., there is no negative performance spillover, not in CPU cycles nor cache pollution. Thus a single misbehaving direction will not prevent traffic in any other direction.

Specifically, a denial of service attack received on single port and direction will never affect more than that single port and direction. For example, a network link that is receiving DDoS traffic in one direction may still be able to send reply traffic in the other direction.

All operations for a single traffic port-pair direction are limited inside a single system partition, thus providing a single CPU cache to each direction which enhances cache-locality and thereby performance of a CPU-based implementation.

Rules applied to one direction will not affect the other direction. This reduces the potential for error when accidentally applying overly broad rules that might inadvertently affect traffic between port pairs other than the targeted port pair.

It becomes possible to download multiple rule-sets for independent ports simultaneously to a large number of ports, thus using parallelism during rule installation.

Bugs in the SWS, triggered by data packets, can be isolated more easily. Only a single process representing a single direction and port pair will be affected, so the scope of any follow-up investigation to find the offending packet, is significantly reduced.

The SWHYPE can be used to filter out malicious packets that might cause an SWS to crash, which limits the damage of running third-party SWS implementations that are not hardened against all attacks.

The SWHYPE approach allows running SWS instances that have virtually identical startup configurations. The difference between the SWS instances is purely the set of runtime rules that they receive from the system, and the traffic that is routed to them.

Each port-pair direction becomes a process which can be controlled on the host computer with standard scheduling abstractions.

### BRIEF DESCRIPTION OF THE DRAWINGS

The drawings are numbered as “Fig. ” followed by a figure number. Sub-elements within each figure are labeled with a number as well. The two rightmost digits of the label represent the element within the figure, while the remaining leftmost digit(s) is the figure number. Each element is labeled in the figure in which it first appears. The following drawings are provided to aid in understanding of the description of the embodiment.

FIG. 1 shows an inline network processing unit consisting of two physical ports, two virtual ports belonging to an SWS instance each (SWS-IN and SWS-OUT), and the SWHYPE.

FIG. 2 shows three example SWHYPE configurations. The case where both physical ports of an SWHYPE unit connect to the same hardware switch, an SWHYPE unit connected to separate hardware switches, and an SWHYPE unit with one end connected to a switch and another to an end-host's NIC. Inbound and outbound links are annotated for illustration purposes.

FIG. 3 shows the forwarding logic for packets handled by SWHYPE.

FIG. 4a shows a single SWS consisting of N ports and FIG. 4b shows the equivalent SWHYPE-based SWS system. Each SWHYPE unit requires two SWS instances and shares NIC ports with other units. The single connection to the centralized controller becomes N * (N-1) connections.

FIG. 5 shows an instance of the SWS, running inside a container, and being attached to its dedicated virtual port. The virtual port is created and managed by the SWHYPE layer.

FIG. 6 shows the mechanisms involved for the containerized processes to connect to the controller that lives in a separate network segment.

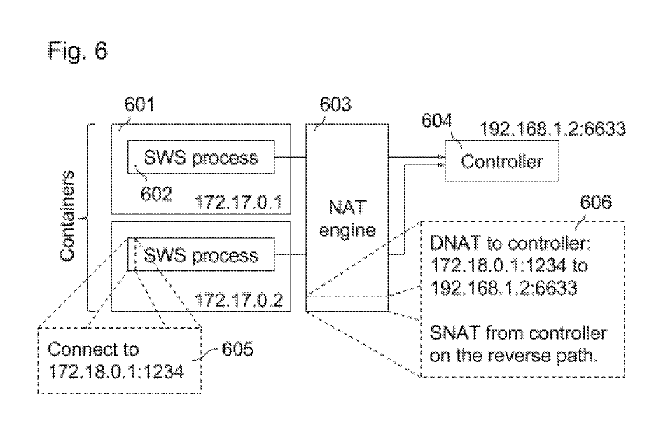

### DETAILED DESCRIPTION OF THE INVENTION

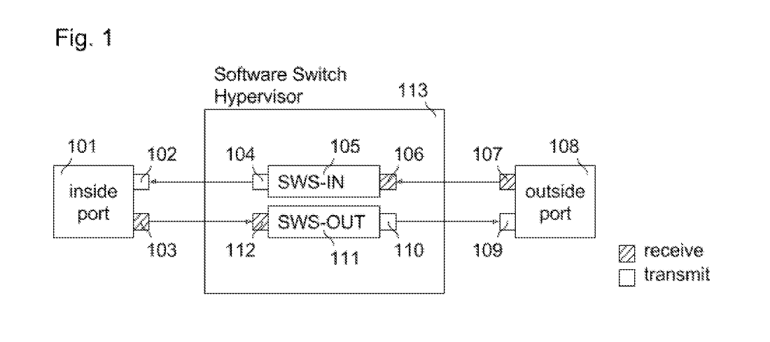

The unit of packet processing in this invention is comprised by an arrangement of two physical ports (the “outside” and the “inside”) and two virtual ports (one handling the inbound direction and the one handling the outbound direction). Directions are defined based on packet flow (see FIG. 1): from the “outside” physical port to the “inside” physical port (inbound direction), or from the “inside” physical port to the “outside” physical port (outbound direction).

FIG. 1 shows an inline network processing unit consisting of two physical ports (101 and 108), two virtual ports belonging to an SWS instance each (SWS-IN 105 and SWS-OUT 111), and the SWHYPE 113. The “outside” physical port and “inside” physical port may be connected to any other physical network element, as long as this outside network device can steer flows to different queues to designate its routing decisions. The connecting rule is that each physical TX function should be connected to a virtual TX function (102 physical connects to 104 virtual and and 109 to 110). And each physical RX function should be connected to a virtual RX function (103 physical connects to 112 virtual and 107 to 106). At the SWS layer the sides cross over. One virtual port of each SWS connects to the TX of the “outside” port and the RX of the “inside” port. The second SWS instance will make the reverse connection from RX of the “outside” port to the TX of the “inside” port. SWS-IN and SWS-OUT are both separate address spaces that cannot access each other's address space, or that of the hypervisor.

For a single bump-in-the-wire application connecting a single physical port pair via the SWS, this invention uses four ports (two backed by physical devices and two entirely virtual ports between SWHYPE and SWS). This is illustrated in FIG. 1 depicting the two physical ports (101 and 108) and the two virtual ports (105 and 111). An SWS instance (105) and the SWHYPE thread responsible for the physical port on its receiving-side (108), are both scheduled to run on the same CPU. This increases cache-locality on the receive path, since packets received on by SWHYPE are consumed by that specific SWS.

Externally the physical interfaces (array of interface pairs 204-205 to 206-207) that are involved in a bump-in-the-wire application (units 201, 202, 203) can be connected to any combination of upstream switches and end-host machines (208, 209, 210). It can be the same upstream switch (208), two separate hardware switches (each port to a different switch, 208 and 209), a hardware switch and an end-host machine (209 and 210), etc.

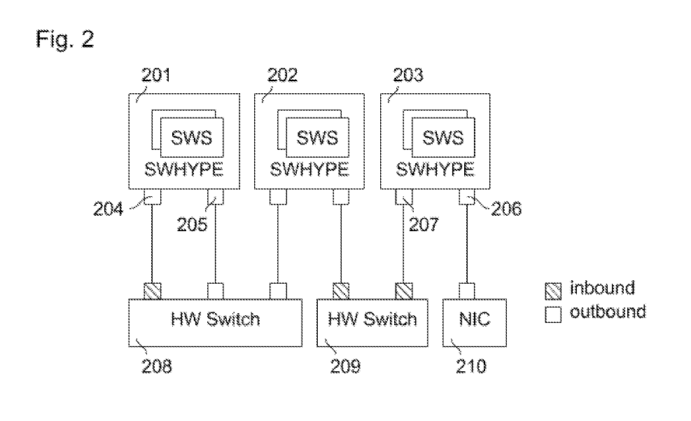

This invention does not require a specific hardware topology for ingress or egress, it can be simply inserted by splitting any wire in two and inserting the split ends into the “outside” and “inside” physical ports that connect to the SWS (see FIG. 2 for a comparison of examples).

Initializing a Processing Unit:

The implementation is based on DPDK, but could just as easily be implemented on other network packet processing frameworks, as long as those create the link between shared memory accessible by a physical network device, that can be attached to by a primary process (the SWHYPE) and a secondary (the SWS). The shared memory is accessible in user space or kernel space depending on where each SWS runs, and the hardware device which is responsible for transmitting data to the physical network. The SWHYPE layer is responsible for initializing an isolation domain and bringing up all ports. This involves allocating memory, e.g., from the Linux hugepages pool, initializing the NIC, system runtime, querying the available physical ports, detaching the OS drivers and attaching userspace drivers used together the memory mapped devices that are to be exposed to SWS. Finally, the SWHYPE initializes the virtual ports that connect to the SWSes. An implementation of an SWS that has been used with this invention is called Open vSwitch (OVS), which is instantiated twice per SWHYPE unit, one instance per direction.

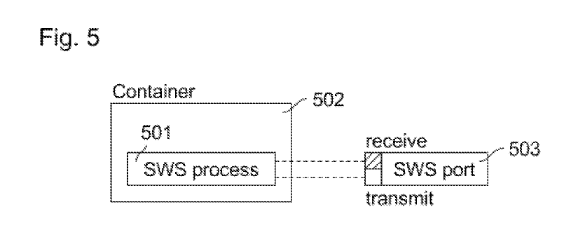

The SWHYPE is not necessarily a full hypervisor in the CPU-hypervisor sense since it only virtualizes the packet forwarding path. The SWHYPE is never used to isolate arbitrary software components, it only isolates arbitrary rule configurations of individual ports and directions of a software switch. The virtualized resources are the RX and TX queues that are presented to the SWS as a virtual port. A virtual port (105 and 111) is mapped to a well-understood OS abstraction, the process (501 in FIG. 5), which is associated with a OS layer resource container a.k.a. container group (502) to achieve performance isolation for the contained process and thereby network traffic. Virtual ports 105 and 111 are the same as 503, observed from the hypervisor's and the container's side respectively.

OVS instances are launched inside Linux containers (502). The implementation uses the Docker software [DOCKER] to automate the setup. Part of the automation allows creating a preconfigured software image of OVS that is run inside the OS process that is launched by Docker. The implementation creates a Docker image of an OVS (501) with a single port that always attaches to the SWHYPE layer. The virtual port's name (503), which a launched OVS container attaches to, is passed to the launcher of the Docker software at run-time.

From the perspective of the SWS 501 the only available port is 503. Packets arriving on the port are processed and sent back to that same port. It's the responsibility of SWHYPE to correctly route packets coming from the SWSes to the appropriate physical port (“inside” port 101 or “outside” port 108) and from physical ports to the appropriate SWS (105 or 111).

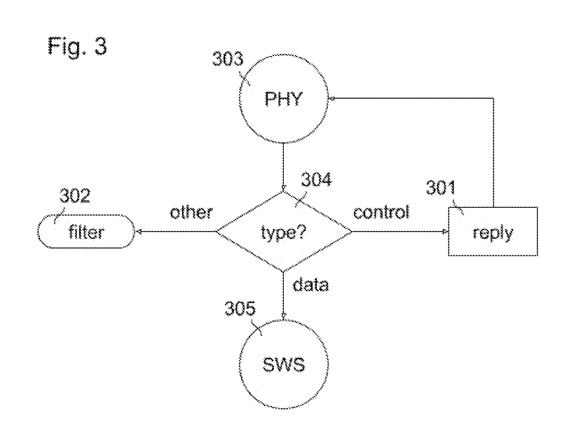

When a packet is received by the SWHYPE hypervisor from a physical port (PHY 303 in FIG. 3 can be the “inside” or “outside” port of FIG. 1), its type is checked (304). It can be a special control packet; for example, a custom switch keep-alive message or an ICMP ping. In that case it's handled there, a reply is constructed (301) and sent to the origin physical port (303). The packet may also be invalid or meet other criteria that qualifies it for early filtering (302); for example, having a destination MAC address of 00:00:00:00:00:00. Otherwise it's considered a data packet and it's forwarded to the SWS (305).

Each SWHYPE unit (402, 403) requires two SWS instances. Each SWS inside an SWHYPE becomes an independent, named entity that is visible and controlled by the centralized controller 404 using a control connection, and attached to a dedicated named virtual port (port 105 or 111).

An example name and naming scheme that is used in this invention for virtual ports is: “appid=ovs,uid=1000,core=0,shard=0”, which uniquely identifies the port based on the application instance that it serves; in this case a containerized Open vSwitch application. There are four parts in this name separated by commas. The appid is the application name, the uid is the running user's id in the operating system, the core number is the CPU core it is executed on, and the shard number is the associated physical port's queue number. The number of attributes may vary, as they are deployment specific. The essence of the attributes is that they allow the grouping of processes, SWSes, and virtual ports that share a given set of attributes as a dis-aggregated virtual switch which for purposes, other than isolation, is treated as a unit. This naming scheme participates in a two-way mapping function: from port name to process configuration and vise versa. If configuration is given in the form of command-line flags, the naming scheme also helps in performing manual administration tasks, because it becomes part of the process table entry of the running process.

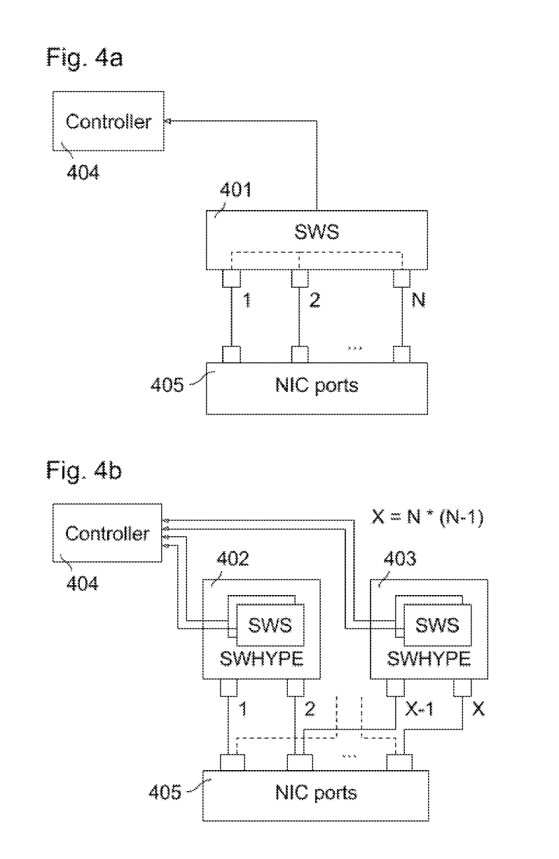

This invention splits a single SWS 401 with N ports and a single control connection, as shown in FIG. 4a, into N * (N-1) SWSes, each with one port (503), and N * (N-1) control connections (arrows arriving at 404), as shown in FIG. 4b. Hence, the system can apply control updates much faster as N * (N-1) rules are sent simultaneously, rather than sending all rules over a single connection to the SWS. The number of NIC ports 405 is equal in both cases. In FIG. 4b, however, SWHYPE units have to share NIC resources (using NIC multi-queue and/or NIC virtualization features) in order to cover all possible direction pairs.

If the number N * (N-1) exceeds the number of CPUs in the system then it will be necessary to allocate some SWS instances to shared cores. The allocation problem is resolved by allocating a fixed number of CPU cores to shared direction pairs using containers and assigning the SWS instances that should be scheduled on those shared cores to the container group representing the shared core pool.

The shared pool destroys isolation for all port-direction pairs that are allocated to the shared pool. However, should any one of the processes in the shared port pool exceed the resource usage of any other port allocated to a dedicated CPU core, then the heavily-loaded process from the shared pool should be swapped in Linux cgroup settings with the process that is less loaded but allocated to a dedicated CPU core, thus restoring isolation.

Establishing a Control Path:

The aforementioned steps describe how an SWS instance connects to the datapath of SWHYPE, but just connecting OVS to SWHYPE is not enough to make it controllable. Therefore, a control channel is established between the OVS instances 602 and an OpenFlow controller 604.

The pre-configured OVS instances is, without loss of generality, always configured to connect to the OpenFlow controller at IP address 172.18.0.1 and port 1234.

Once the Docker software (601) has successfully launched the OVS process (602) it will attempt connecting to 172.18.0.1:1234 (605) over its own virtual interface using a TCP connection. Every OVS instance under the same SWHYPE will attempt connecting in the same manner.

The SWHYPE process installs Network Address Translation (NAT) rules in the NAT engine (603), that redirect 172.18.0.1:1234 to the endpoint of the active OpenFlow controller that is in charge of the SWS layer (606). The NAT rules apply to all virtual networks, from which containers establish control connections.

Furthermore the naming scheme introduced above for SWSes, is used as a means of aggregating SWS instances into collections that fall under the same controller. The aggregation happens by requiring a match for a subset of their attributes. After the collections are formed it's a matter of applying the NAT rules to the specific containers in the pool so that they connect to the designated controller.

Also, for the sake of this example, it is assumed that the two physical ports involved in an SWHYPE unit, are connected to the same OpenFlow-enabled hardware switch. This setup of one or more SWHYPES and a hardware switch presents a fully managed system. It is the responsibility of the hardware switch to steer packet flows towards the target physical ports that connect to the SWSes and also push rules to the SWS instances handling the two directions of the very same packet flows. In this manner, it becomes possible to apply a very large set of rules to packet flows at the SWS after first separating these flows at the hardware switch.

Identifying OVS Instances:

When the SWHYPE first starts, each physical port is configured to have a globally unique id. The id of the physical port on the receiving-side of OVS's virtual port is used to create a unique name for this virtual port, and from that a unique datapath id. This datapath id is used when OVS attempts to connect to the OpenFlow controller, so that the controller in turn knows where to push what rules. It's assumed that all relevant information the controller might need, for example the direction handled by an OVS, is encoded in the unique datapath id.

### Conclusion:

What is described herein is a new method of allocating network processing, through Network Programs (NPs), in Software Switches (SWSes) to CPUs. This new method leverages CPU isolation to achieve performance isolation and performance predictability at the network layer (packets and bits per second) across all port pairs of a software switch. Furthermore, the new method provides isolated control paths from an OpenFlow controller to each forwarding direction providing fine-grained isolation between port pairs on the control path, too. Finally, this method introduces an early pre-filtering stage at the SWHYPE layer that allows for protecting the SWSes from specific types of traffic, for example, invalid packets that could trigger known bugs.

What is claimed is:

1. An apparatus for network traffic performance, fault, and rule-space isolation between ports on a general purpose CPU, comprising:
a host computer;
an operating system;
per process resource containers;
a means for configuring and starting said Software Switch Instances (SWSes) as processes;
a network interface card with a plurality of receive and transmit queues per port;
a means to allocate a pair of RX, TX queues to a single SWS by configuration;
a means for transforming the configuration of a single SWS with multiple ports into a collection of SWSes each responsible for a set of inbound and outbound pairs;
a means to instruct the SWS to pass traffic from its RX to its TX queue,
a means for controlling the resources of a SWS;
a means for centrally controlling the rules that the SWSes apply to each packet;

2. The apparatus of claim 1, wherein each SWS is allocated to a CPU set.

3. The apparatus of claim 1, wherein an SWS connects to a specific externally-addressable incoming network device function,
such that an external network controller can
target network traffic partitions to specific SWSes
by directing packets to the specific external address.

4. The apparatus of claim 1, wherein the SWS instances execute inside Operating System resource containers.

5. The apparatus of claim 1, wherein one or more SWS are allocated to handle excessive packet-rate or excessive bandwidth traffic.

6. The apparatus of claim 1, wherein each SWS reads its own individual configuration.

7. The apparatus of claim 1, wherein:
each SWS is packaged as a preconfigured image in a package file,
said file having a defined execution entry point,
and such file being passed to an execution engine,
said execution allowing parameters for the launch of the SWS being passed at runtime,
and said execution engine launching the SWS contained in said file with additional runtime parameters that are passed to it.

8. The apparatus of claim 1, wherein outgoing connection attempts by the SWS instances are intercepted and optionally redirected to a different redirection destination address,
with redirection address being different from the intercepted destination address,
with the determination of the redirection destination address occurring at runtime.

9. The apparatus of claim 1, wherein a software switch hypervisor process (SWHYPE) is inserted between the NIC and the SWS in order to
relay,
multiplex,
demultiplex,
and filter packets between a NIC and the SWS.

10. The extended apparatus of claim 9, wherein
the NIC is configured to dispatch received packets into memory local a specific CPU,
each SWHYPE also executes on said CPU,
and each SWS subordinate to said SWHYPE also to executes on said CPU.

11. A method of grouping Software Switch Processes representing the top-k SWS instances ordered by some metric into a group of Processes for shared resource allocation.

12. The method of updating the top-k set of claim 11, dynamically as the resource metric changes over time.

13. A method of naming virtual ports in a software switch in a self-descriptive, attribute-value pair type manner.

14. The method of the naming scheme of claim 13, in order to create a centralized control aggregate for a collection of SWSes, which have matching attributes in one or more fields of their names, and direct the control connection of each SWS in said collection of SWSes to a single shared controller.
